(19) United States
(12) Patent Application Publication
(10) Pub. No.: US 2012/0098748 A1
(43) Pub. Date: Apr. 26, 2012

(54) BUTTON ASSEMBLY AND COMPUTER MOUSE HAVING THE SAME

(75) Inventor: HSIEN-TA LIN, Tu-Cheng (TW)

(73) Assignee: HON HAI PRECISION INDUSTRY CO., LTD., Tu-Cheng (TW)

(21) Appl. No.: 12/953,498

(22) Filed: Nov. 24, 2010

(30) Foreign Application Priority Data
Oct. 21, 2010 (CN) 201010514758.9

(51) Int. Cl. G06F 3/033; G01S 15/00

(52) U.S. Cl. 345/163; 367/87

(57) ABSTRACT

A computer mouse includes a housing and a button assembly. The button assembly includes a button, a circuit board, an infrasonic emitter, and an infrasonic receiver. The infrasonic emitter is mounted on the circuit board and emits infrasonic wave. The infrasonic receiver is mounted on the circuit board and is separated from the infrasonic emitter. The infrasonic receiver receives the infrasonic wave from the infrasonic emitter. When the button is pressed, the button impedes a passage of the infrasonic wave from the infrasonic emitter to the infrasonic receiver.

### BACKGROUND

1. Technical Field

The present disclosure relates to button assemblies and, particularly, to a noiseless button assembly and a computer mouse having the button assembly.

2. Description of Related Art

A typical computer mouse includes two buttons and a circuit board. Each button includes a metal plate fixed thereon, and two contacts corresponding to each button are formed on the circuit board. When the button is pressed, the metal plate of the button will electrically connect the two contacts, and therefore, an electrical signal is transmitted between the two contacts to execute a command of the computer mouse. However, because of the impact between the metal plate and the contacts, a very unpleasant mechanical noise is emitted while pressing the button.

What is needed, therefore, is a computer mouse to overcome or at least mitigate the above-described problem.

### BRIEF DESCRIPTION OF THE DRAWINGS

The components of the drawings are not necessarily drawn to scale, the emphasis instead being placed upon clearly illustrating the principles of the embodiments of the display device. Moreover, in the drawings, like reference numerals designate corresponding parts throughout several views.

FIG. 1 is a schematic view of a computer mouse according to an exemplary embodiment.

FIG. 2 is a cross-sectional view of the computer mouse of FIG. 1.

### DETAILED DESCRIPTION

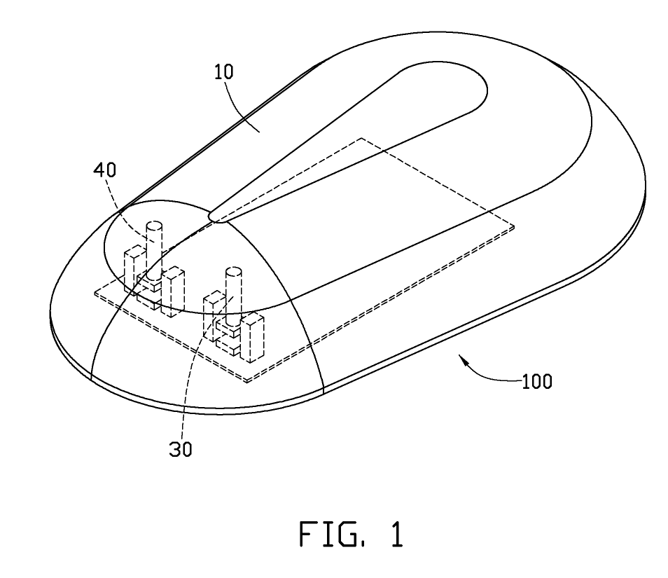

Referring to FIG. 1, a computer mouse 100 includes a housing 10, a first button assembly 30, and a second button assembly 40. The first button assembly 30 and the second button assembly 40 are positioned near an end of the computer mouse 100. In this embodiment, the first button assembly 30 and the second button assembly 40 are a left button and a right button of the computer mouse 100, respectively.

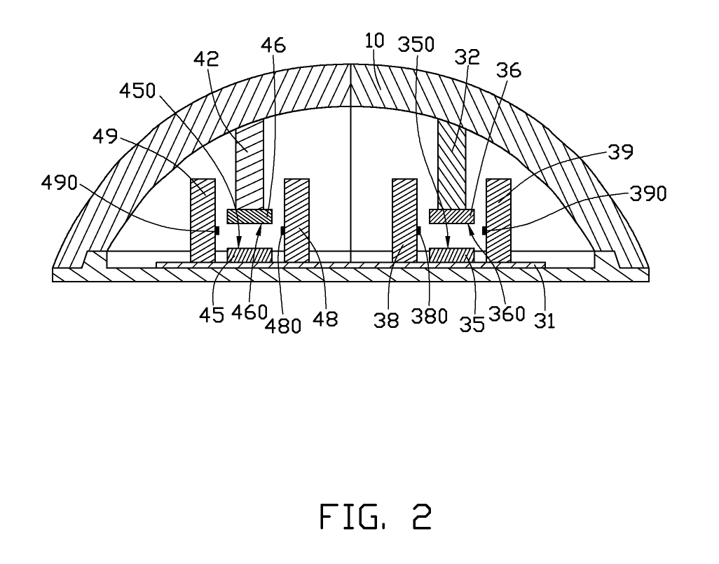

Referring to the FIG. 2, the first button assembly 30 includes a circuit board 31, a button 32 connecting the housing 10, a first magnet 35, and a second magnet 36. The circuit board 31 is received in the housing 10 and separated from the button 32. The first magnet 35 and the second magnet 36 are located between the circuit board 31 and the button 32. The first magnet 35 is mounted on the circuit board 31. The second magnet 36 is fixed to a bottom end of the button 32. The first magnet 35 and the second magnet 36 are in alignment with the button 32. An upper surface 350 of the first magnet 35 and a lower surface 360 of the second magnet 36 have a same polarity.

The first button assembly 30 further includes an infrasonic emitter 38 and an infrasonic receiver 39 mounted on and electrically connected to the circuit board 31. The infrasonic emitter 38 and the infrasonic receiver 39 are respectively located on two opposite sides of the button 32. The infrasonic emitter 38 includes an emitting point 380, and the infrasonic receiver 39 includes a receiving point 390. A line interconnecting the emitting point with the receiving point 390 is positioned between the upper surface 350 of the first magnet 35 and the lower surface 360 of the second magnet 36.

When the first button assembly 30 is at an original state, the second magnet 36 is separated from the first magnet 35, the emitting point 380 of the infrasonic emitter 38 emits infrasonic wave to the receiving point 390 of the infrasonic receiver 39. In use, when the button 32 is pressed, the second magnet 36 moves toward the first magnet 35. The button 32 with the second magnet 36 impedes the passage of the infrasonic wave from the emitting point 380 of the infrasonic emitter 38 to the receiving point 390 of the infrasonic receiver 39, and the circuit board 31 receives a control signal. When the button 32 is released, since the upper surface 350 of the first magnet 35 and a lower surface 360 of the second magnet 36 have a same polarity, the first magnet 35 applies a repulsive force to the second magnet 36 to return the button to its original position and the infrasonic receiver 39 resumes receiving the infrasonic wave emitting from the infrasonic emitter 38. Thus, the control signal of the first button assembly 30 is discontinued.

The second button assembly 40 includes a configuration similar to the first button assembly 30. The second button assembly 40 includes a button 42 connecting the housing 10, a first magnet 45, and a second magnet 46. The first magnet 45 and the second magnet 46 are located between the circuit board 31 and the button 42. The first magnet 45 is fixed on the circuit board 31 and separated from the second magnet 46 fixed to a bottom end of the button 42. The second button assembly 40 further includes an infrasonic emitter 48 and an infrasonic receiver 49 mounted on and electrically connected to the circuit board 31. The infrasonic emitter 48 includes an emitting point 480, and the infrasonic receiver 49 includes a receiving point 490. In this embodiment, the infrasonic emitter 48 is near the infrasonic emitter 38 of the first infrasonic emitter 38. The emitting point 480 and the emitting point 380 are positioned back to back. The working process of the second button assembly 40 is the same as the first button assembly 50, thus it is omitted here.

Since the button 32 of first button assembly 30 and the button 42 of the second button assembly 40 impedes the infrasonic receiver 39 and 49 to receive the infrasonic wave to produce the control signal. Therefore, the impact between the second magnet 36 and 46 and first magnet 35 and 45 can be avoided, and the mechanical noise caused by the impact can be eliminated. Furthermore, because the upper surface 350 and 450 of the first magnets 35 and 45 and the lower surface 360 and 460 of the second magnets 36 and 46 have a same polarity, the buttons 32 and 42 can elastically return.

It is to be understood, however, that even though numerous characteristics and advantages of certain embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A computer mouse comprising:
a housing; and
a button assembly, the button assembly comprising:
a button;
a circuit board;
an infrasonic emitter mounted on the circuit board, and emitting infrasonic wave; and
an infrasonic receiver mounted on the circuit board and separated from the infrasonic emitter, the infrasonic receiver receiving the infrasonic wave from the infrasonic emitter;
wherein when the button is pressed, the button impedes a passage of the infrasonic wave from the infrasonic emitter to the infrasonic receiver.

2. The computer mouse of claim 1, wherein the button assembly further comprises a first magnet mounted on the circuit board and a second magnet fixed to the button, the second magnet and the first magnet forming a repulsive force therebetween.

3. The computer mouse of claim 2, wherein a lower surface of the second magnet facing an upper surface of the first magnet, and the upper surface of the first magnet and the lower surface of the second magnet have a same polarity.

4. The computer mouse of claim 1, wherein the infrasonic emitter comprises an emitting point to emit the infrasonic wave, and the infrasonic receiver comprises a receiving point to receive the infrasonic wave.

5. The computer mouse of claim 4, wherein the emitting point and the receiving point face each other.

6. The computer mouse of claim 1, further comprising an additional button assembly, the additional button assembly comprising an infrasonic emitter emitting infrasonic wave, an infrasonic receiver receiving the infrasonic wave, and a button impeding a passage of the infrasonic wave when the button is pressed, the infrasonic emitter of the additional button assembly being near the infrasonic emitter of the button assembly.

7. A button assembly comprising:
a button;
a circuit board;
an infrasonic emitter mounted on the circuit board, and emitting infrasonic wave; and
an infrasonic receiver mounted on the circuit board and separated from the infrasonic emitter, the infrasonic receiver receiving the infrasonic wave from the infrasonic emitter;
wherein when the button is pressed, the button impedes a passage of the infrasonic wave from the infrasonic emitter to the infrasonic receiver.

8. The button assembly of claim 7, further comprising a first magnet mounted on the circuit board and a second magnet fixed to the button, the second magnet and the first magnet forming a repulsive force therebetween.

9. The button assembly of claim 8, wherein a lower surface of the second magnet facing an upper surface of the first magnet, and the upper surface of the first magnet and the lower surface of the second magnet have a same polarity.

10. The button assembly of claim 7, wherein the infrasonic emitter comprises an emitting point to emit the infrasonic wave, and the infrasonic receiver comprises a receiving point to receive the infrasonic wave.

11. The button assembly of claim 10, wherein the emitting point and the receiving point face each other.
